(19) United States
(12) Patent Application Publication
(10) Pub. No.: US 2016/0152932 A1
(43) Pub. Date: Jun. 2, 2016

(54) CROSS-FLOW FILTRATION SYSTEM FOR VITICULTURE

(71) Applicant: MAHLE INTERNATIONAL GMBH, Stuttgart (DE)

(72) Inventors: Matthias Herb, Ebersbach (DE); Sebastian Munz, Leutenbach (DE); Ulrich Oechsle, Schwaebisch Grmuend (DE); Marco Schoop, Rudersberg (DE)

(73) Assignee: Mahle International GmbH, Stuttgart (DE)

(21) Appl. No.: 14/905,930

(22) PCT Filed: Jul. 17, 2014
(86) PCT No.: PCT/EP2014/065402

§ 371 Date: Jan. 18, 2016

(30) Foreign Application Priority Data
Jul. 18, 2013 (DE) 10 2013 214 090.8

(51) Int. Cl. C12H 1/07; B01D 61/20; B01D 63/04

(52) U.S. Cl. CPC C12H 1/063; B01D 63/046; B01D 61/20; B01D 2313/105; B01D 2313/125; B01D 2315/10; B01D 2317/04

(57) ABSTRACT

A cross-flow filtration system for filtering a suspension, such as but not limited to a viniculture suspension, may include a plurality of hollow fibre modules for retaining a retentate of the suspension. A circulation pump may be fluidically connected to the hollow fibre modules for facilitating a mechanical flow of the suspension. A flow distributor may distribute the suspension to the hollow fibre modules. A flow collector may collect the suspension of the hollow fibre modules. The flow distributor and the flow collector may be fluidically connected to the circulation pump and the hollow fibre modules. The hollow fibre modules may be arranged coaxially to each other about a longitudinal axis of the cross-flow filtration system.

### CROSS-REFERENCE TO RELATED APPLICATIONS

This application claims priority to German Patent Application No. 10 2013 214 090.8, filed Jul. 18, 2013, and International Patent Application No. PCT/EP2014/065402, filed Jul. 17, 2014, both of which are hereby incorporated by reference in their entirety.

### TECHNICAL FIELD

The invention relates to a cross-flow filtration system and a method for cross-flow filtration.

### BACKGROUND

In the technical language of viticulture, all tasks that are associated with turning grapes into wine in the period from the end of fermentation until a wine is bottled are considered to be part of the process of “aging”. In this context, the prior art includes an enormous variety of processes and apparatuses designed to improve the wine's complexity or structure. Besides an initial blending and racking step of the new wine, these aging processes typically also include a careful filtration step, which particularly serves to remove unwanted substances in suspension. Such suspended substances in plant-based drinks, which in the case of wine may include crystals, proteins, colloids, yeasts or tannins from the flesh or skins of the grape, are referred to in the food technology industry as turbidity—lees in winemaking—and are filtered out in a process called fining, because they tend to impair quality if they are left in the wine during storage. Such a treatment after the end of the production process may be carried out in the course of a wide range of clarification methods.

For this purpose, WO 2013/054966 A1 suggests a filtration system having a plurality of filter units which, besides functions that are concentrated in the upper area thereof, also include a discharge section for discharging foreign bodies after back-flushing, with a filter and a back-flush line. Discharge tubes of each filter unit are then arranged in a single row. According to WO 2013/054967 A1, each filter unit also has an automatic cleaning section, in which a differential pressure is created in at least one specific area relative to the pressure in a body. These cleaning sections are actuated one after the other under the control of a control section. WO 2013/054968 A1 completes the apparatus described with a specific counterpressure prevention tank on a back-flush line for back-flushing and separating various foreign substances.

One drawback of these suggestions, which originate from the clarification of ballast water on ships, lies in the fact that they can only be transferred to beverage filtering applications with limited success. In this scenario, the pore size of such ballast water filters alone has rendered them largely unsuitable for wine.

### SUMMARY

One object of the invention therefore consists in providing a filtration system that is particularly effective in improving the quality of wines. A further object consists in creating a corresponding method.

These objects are solved with a cross-flow filtration system as disclosed herein.

Accordingly, the invention is based on the fundamental idea of using an arrangement of axially parallel filter modules constructed with “polar” alignment in the manner of a star about a central axis, creating a compact structure that enables the separation of an extremely wide variety of lees. Apart from its compact dimensions and a correspondingly harmonious general appearance, a filtration system having such a module construction enables the largely uniform distribution of pressure within its filter modules, resulting in an extremely homogeneous flow field.

In this context, each filter module comprises hundreds of “hollow filaments” or “hollow fibres” that are encapsulated (“potted”) on both sides to prevent hydraulic short circuit, and of which the partially permeable walls function as a membrane, and as such are also familiar to a person skilled in the art as capillary membranes. These hollow fibre modules are implemented as the basis of a method known in membrane technology as cross-flow or tangential flow filtration, according to which wine or a similar suspension for filtration is pumped through the hollow fibre modules at high speed, and the permeate is drawn off tangentially to the direction of flow. The arrangement according to the invention ensures that the cross-flow filtration system is supplied particularly evenly, and thus creates a substantially identical volume flow of the suspension in all of the hollow fibre modules, with the result that the retentate trapped in the modules is only able to “cake” slowly on the capillary membranes, if at all. By preventing this covering layer from being formed inside the hollow fibre modules, also called fouling, the suggested arrangement thus enables the cross-flow filtration system to be operated economically for long periods, with only minor increase in the flow resistance built up in response to the suspension. In this manner, the power consumption of a circulating pump that is used to circulate the suspension can be kept largely constant for a relatively long time without any significant reduction in the volume flow achieved in the hollow fibre modules. The pinch effect of hollow fibres, which is known in fluid mechanics and allows a tendency towards establishment of an equilibrium of the lees in an eccentric radial position of the cylindrical modules when the pump is operating for continuously, slows fouling further. The solution according to the invention further enables gentle filtration of the suspension.

In preferred variants, the filter modules are arranged in axially parallel manner about a longitudinal axis of the cross-flow filtration system. This too helps to create a flow through the filter modules that is as homogeneous as possible. This means that when the fluid flows through the filter modules there is little or no hierarchy among the filter modules. This lack of hierarchy is reflected particularly in the fact that the volume flows, pressures and particle loads are substantially the same in all of the filter modules.

The homogeneity of the throughflow is improved if the filter modules are located at the same perpendicular distance from the longitudinal axis. If the direction transverse to the longitudinal axis is described as radial, this means that the filter modules are preferably arranged so as to be radially equidistant from the longitudinal axis.

In preferred embodiments of the cross-flow filtration system, the even distribution of volume flow to all hollow fibre modules that is sought according to the invention is favoured by the specific geometry of the flow distributor and collector provided at one end, and which is supported on a preferably conical body of rotation, a right circular cone, for example.

In addition, variations in which the filter modules are arranged with rotational symmetry about the longitudinal axis are particularly preferred. Such a variation creates an homogeneous flow field or improves the homogeneity thereof, wherein the homogeneous flow field means that the liquid flows through all of the filter modules evenly.

The circulating pump that is used to circulate the suspension through the cross-flow filtration system is advantageously one that is designed and/or installed in the cross-flow filtration system in such manner that it causes the suspension to flow through the filter modules multiple times. This means that he circulating pump circulates the suspension through the cross-flow filtration system and through the filter module. The circulating pump thus particularly has the form of a recirculation pump. In such an arrangement, a certain amount of retentate is filtered out of the suspension each time the suspension flows through such a filter module. It is then advantageous to introduce fresh suspension into the cross-flow filtration system to make up for the quantity that has been removed from the flow. To this end, a displacement device, particularly a pump, may be provided. It may further be provided that the suspension is circulated several tens of times, particularly fifty times, before it leaves the cross-flow filtration system as filtrate.

Other important features and advantages of the invention will be evident from the subordinate claims, the drawings and the associated description of the figures with reference to the drawings.

Of course, the features described in the aforegoing and those that will be explained in the following text are usable not only in the combinations described, but also in other combinations or by themselves without departing from the scope of the present invention.

Preferred embodiments of the invention are represented in the drawings, and are explained in greater detail in the following description, in which identical or similar or functionally equivalent components are identified with the same reference signs.

### BRIEF DESCRIPTION OF THE DRAWINGS

In the drawings, which are all schematic in nature:

FIG. 1 is a perspective view of a filtration system according to a first embodiment,

FIG. 2 is a side view of the filtration system according to the first embodiment,

FIG. 3 is a longitudinal cross section through the filtration system according to the first embodiment,

FIG. 4 is a plan view of the filtration system according to the first embodiment,

FIG. 5 is the longitudinal cross section of a flow distributor of the filtration system according to the first embodiment,

FIG. 6 is the perspective view of a filtration system according to a second embodiment,

FIG. 7 is a plan view of the filtration system according to the second embodiment,

FIG. 8 is a longitudinal cross section through the filtration system according to the second embodiment, and

FIG. 9 is the longitudinal cross section of a flow collector of the filtration system according to the second embodiment.

### DETAILED DESCRIPTION

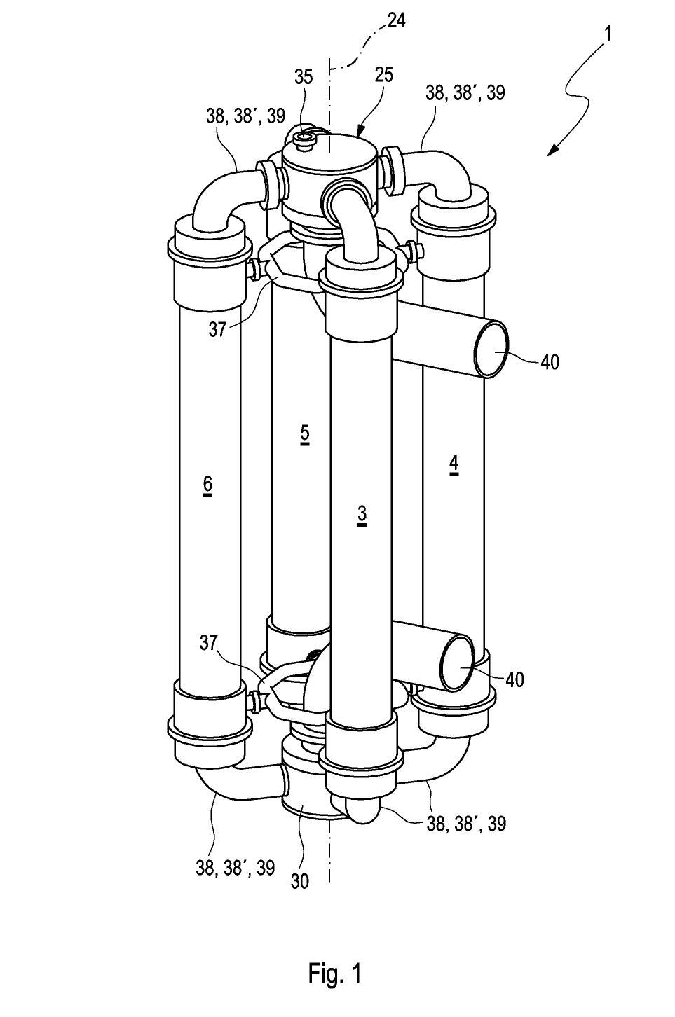

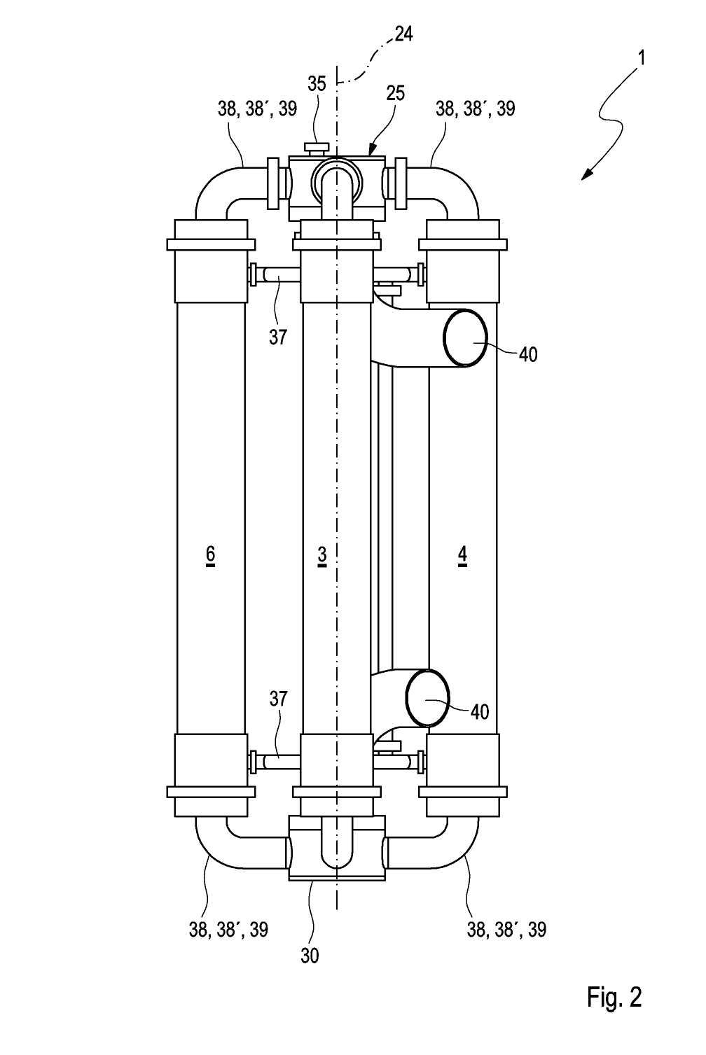

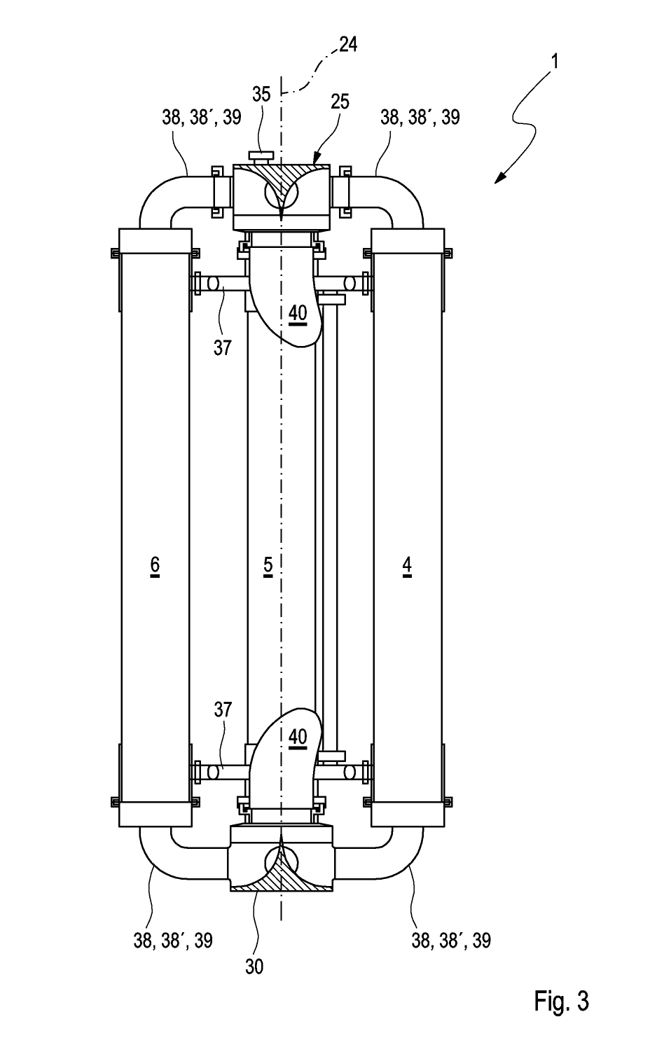

FIGS. 1 to 5 illustrate the structure of a cross-flow filtration system 1 having four substantially identical cylindrical hollow fibre modules 3, 4, 5, 6 arranged equidistantly about a longitudinal axis 24 or longitudinal centre line 24, and of which the identical height is several times greater than the diameter. In this context, according to the technical language used in membrane technology, a hollow fibre is considered to be any approximately cylindrical fibre that has a cross section with one or more largely continuous cavities, so that the wall thereof is able to function as a membrane filter. For this purpose, the hollow fibres of the embodiment shown have a length between 2 cm and 2 m, an internal diameter between 0.1 μm and 3 mm, and a pore size between 100 nm and 2 μm, which enables them to reliably trap undesirable solid particles in the lees of a new wine in its current form as a suspension. Mechanical separation methods using a membrane with the pore size indicated are known in professional circles and are described generally as microfiltration.

Besides ceramics and sintered metal, materials used for such particularly include fibres with a base of polyethersulfone (PESU), polysulfone (PSU), polyacrylonitrile (PAN), polytetrafluoroethylene (PTFE), polypropylene (PP), polyethylene (PE), polyvinylidene fluoride (PVDF) or other polymers, which are produced by phase inversion in the wet spinning process, for example, and optionally—in the case of polytetrafluoroethylene, polypropylene or polyethylene, for example—sintered or extruded or stretched.

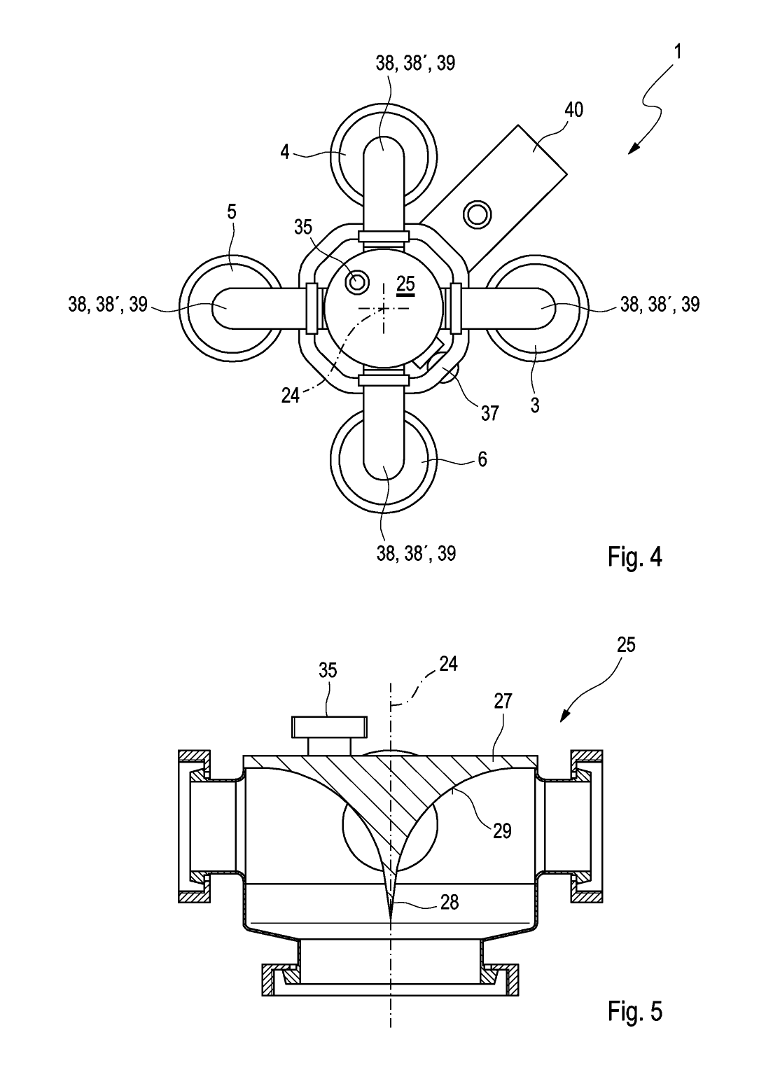

According to the invention, as is shown particularly in FIGS. 1 to 4, the hollow fibre modules 3, 4, 5, 6, configured in this way, are arranged in essentially axially parallel manner and form the corners of square whose sides are approximately three times as long as the module diameter, as shown in the plan view of FIG. 4. Hollow fibre modules 3, 4, 5, 6 are also positioned on a circle whose centre point is intersected by longitudinal axis 24, wherein hollow fibre modules 3, 4, 5, 6 are arranged rotationally symmetrically about longitudinal axis 24. In the example of four hollow fibre modules 3, 4, 5, 6 shown here, the angle of symmetry is approximately 90°.

In a spatial plane corresponding to the upper face area of cross-flow filtration system 1, on which the representation in FIG. 4 is based, a flow distributor 25 is arranged at an equal distance from all of the hollow fibre modules 3, 4, 5, 6, and by virtue of its specific geometry and arrangement is able to cause a diversion of part of the suspension flowing through cross-flow filtration system 1 to each of the four hollow fibre modules 3, 4, 5, 6. In this context, the heart of flow distributor 25, a cross section of which appears particularly in FIG. 5, is a first body of rotation 27 which is delimited by first lateral surface 29, and of which the side facing the centre point of cross-flow filtration system 1 is charged centrally by a circulation pump—not shown in FIGS. 1 to 5. In the present embodiment, first lateral surface 29 is formed by the rotation of an exponential function about a straight line corresponding to the central axis of cross-flow filtration system 1, in which direction it thus tapers to a point. A fitting pointing away from the tip 28 formed in this way is conformed on the upper base area of body of rotation 27 and serves solely as an optional vent 35 to remove unwanted gas, particularly air, which—since it has a lower density than the suspension—tends to collect as a gas bubble at the highest point of flow distributor 25 in the cross-flow filtration system 1.

A flow collector 30 arranged and configured as a counterpart to flow distributor 25 is also provided in a spatial plane corresponding to the lower face area of cross-flow filtration system 1 and equidistantly from all hollow fibre modules 3, 4, 5, 6, and thus also coaxially with flow distributor 25. Accordingly, flow collector 30 is arranged along longitudinal axis 24 opposite flow distributor 25 and at a distance from flow distributor 25.

Hollow fibre modules 3, 4, 5, 6 are each connected fluidically to flow distributor 25 via a connecting section 38 and fluidically to flow collector 30 via a connecting section 38. Connecting sections 38 each have the form of a connecting pipe 38′. Connecting sections 38 are designed as non-variable parts 39. Connecting sections 38 are also arranged with the same rotational symmetry as hollow fibre modules 3, 4, 5, 6.

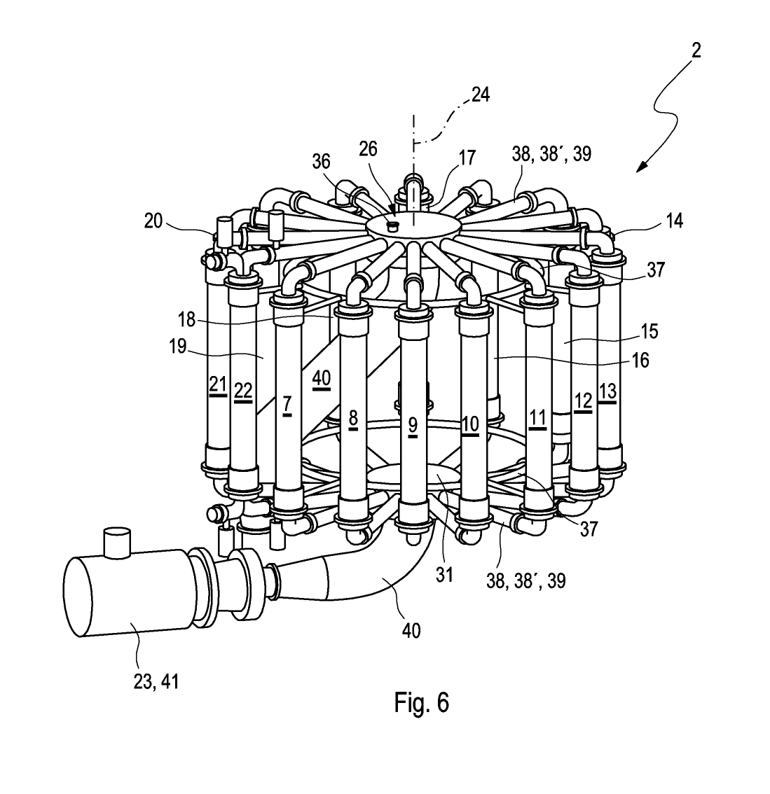

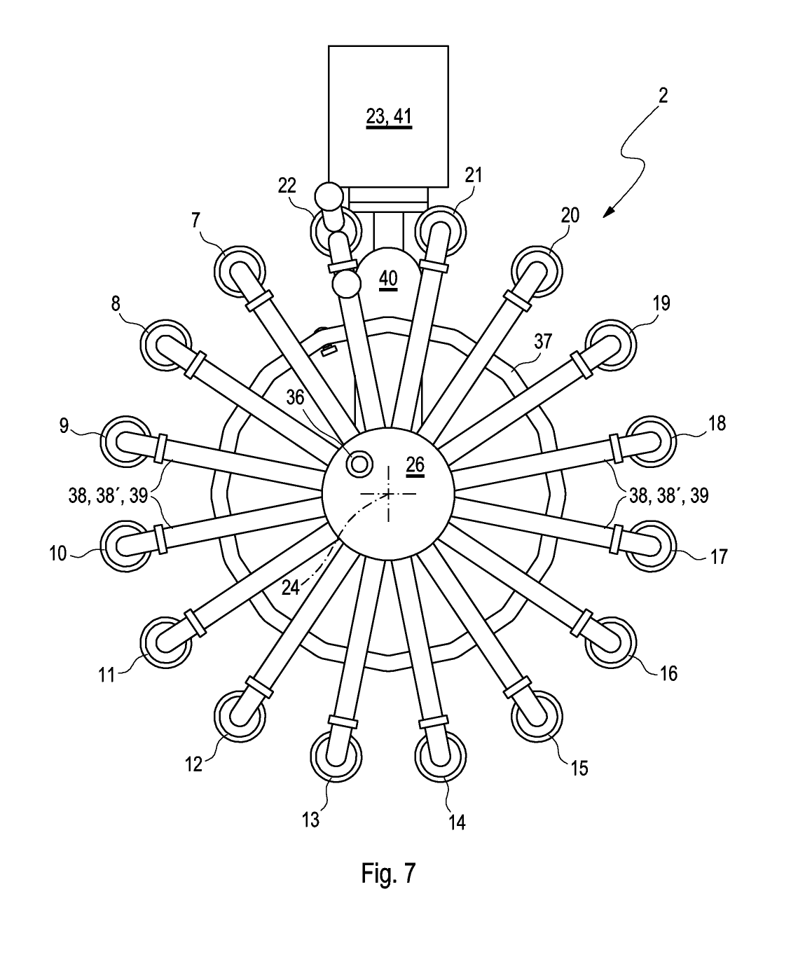

FIGS. 6 to 9 illustrate the structure of another cross-flow filtration system 2 having a total of sixteen hollow fibre modules 7-22 and connecting sections 38 that have substantially the same structure as hollow fibre modules 3, 4, 5, 6 of cross-flow filtration system 1. Particularly the plan view in FIG. 7 represents a rack 37 with a hollow profile that stabilises sixteen hollow fibre module 7-22 in a hexadecagonal arrangement with axially parallel alignment. Besides a flow distributor 26 with similar vent 36 identical construction to the flow distributor 25 of cross-flow filtration system 1 shown in FIG. 5, the cross-flow filtration system 2 also comprises a corresponding flow collector 31, the details of which are made evident in FIG. 9. Accordingly, the primary component of flow collector 31 is a second body of rotation 32, whose peripheral second lateral surface 34 is charged isogonally through the hollow fibre modules 7-22, and which guides the suspension that reaches it to circulation pump 23—only shown in FIGS. 6, 7 and 8—in an extension of the second point 33 formed by the concave shaping of second lateral surface 34.

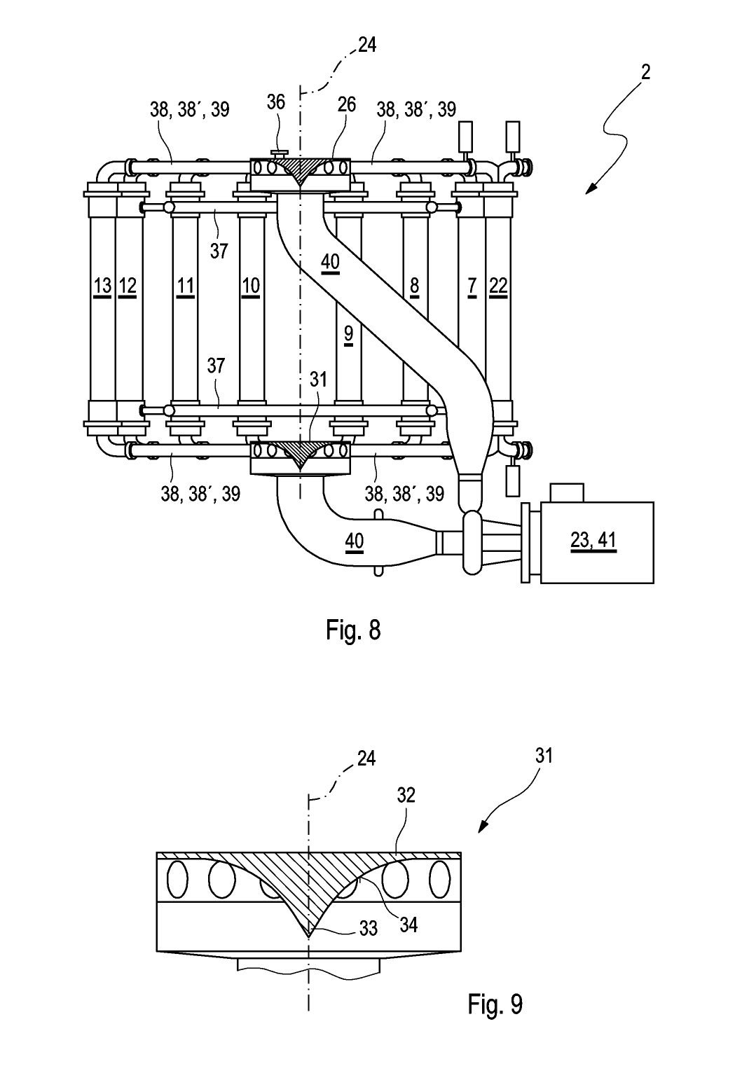

As is shown particularly clearly in FIG. 8, circulation pump 23 is connected fluidically to flow distributor 26 and flow collector 31 via respective connecting lines 40. Circulation pump 23 is also designed so as to circulate the suspension in cross-flow filtration system 2. This means in particular that the suspension coming from hollow fibre modules 7-22 that is collected by flow collector 31 is then forwarded to flow distributor 26, where the suspension is distributed evenly to the hollow fibre modules 7-22. Then, the suspension returns to flow collector 31. Circulating pump 23 is thus designed particularly as a recirculating pump 41. The suspension may be recirculated repeatedly in order to achieve a desired level of filtration of the suspension.

FIGS. 6 and 7 further show that hollow fibre modules 7-22 are arranged rotationally symmetrically about longitudinal axis 24. In this context, the angle of symmetry is approximately 22.5°. The same applies to connecting sections 38 for connecting the hollow fibre modules 7-22 with flow distributor 26 and flow collector 31. It also results in the hollow fibre modules 7-22 being arranged radially equidistantly from longitudinal axis 24.

A rack 37 such as is shown in the example of FIGS. 1 to 4 also appears here. Here too, rack 37 serves to stabilise and support the hollow fibre modules 3-6 arranged in axially parallel manner.

The respective cross-flow filtration system 1, 2 is advantageously a self-contained system that can be implemented autonomously for filtering a suspension.

The suspension flows through hollow fibre modules 3-22 in parallel. The flow through the hollow fibre modules 3-22 also takes place in the same direction, namely from flow distributor 25 towards flow collector 30. In this way, the suspension is redirected as little as possible during filtration, and consequently the filtration the suspension is performed particularly gently.

During filtration of a suspension, particularly of a wine, a retentate of the suspension is trapped by the at least three substantially cylindrical hollow fibre modules 3-22, wherein circulation pump 23 generates a mechanical flow of the suspension. In this context, flow distributor 25, 26 distributes the suspension to hollow fibre modules 3-22, while flow collector 30, 31 collects the suspension from the hollow fibre modules 3-22. Flow distributor 25, 26 and flow collector 30, 31 are fluidically connected to circulation pump 23 and hollow fibre modules 3-22, and are arranged substantially centrally on longitudinal axis 24 of cross-flow filtration system 1, 2. The suspension flows through hollow fibre modules 3-22 parallel to longitudinal axis 24.

In this context, the flows exiting hollow fibre modules 3-22 are preferably collected in flow collector 30, 31. This means that the flow collector 30, 31 is not used to introduce any stream into the hollow fibre modules 3-22. In other words, flow collector 30, 31 serves to collect the suspension as it flows out of the hollow fibre modules 3-22 and transport them on. Distribution or splitting of the suspension to the various hollow fibre modules 3-22 is assured by flow distributor 25, 26. In this context, flow distributor 25, 26 is advantageously designed such that this splitting takes place homogeneously, with the result that an equal fraction of the suspension flows through each of the hollow fibre modules 3-22.

Flow collector 30, 31 is also preferably configured such that it collects the suspension coming from the hollow fibre modules 7-22 evenly. This also helps to assure a homogeneous, non-hierarchical flow of the suspension through cross-flow filtration system 1, 2. In this context, it may be provided particularly that the flow collectors 30, 31 and the flow distributor 25, 26 are designed as non-variable parts.

1. A cross-flow filtration system for filtering a suspension, comprising:
a plurality of cylindrical-shaped hollow fibre modules for retaining a retentate of a suspension,
a circulation pump fluidically connected to the plurality of hollow fibre modules for facilitating a mechanical flow of the suspension,
a flow distributor for distributing the suspension to the plurality of hollow fibre modules, and
a flow collector for collecting the suspension from the plurality of hollow fibre modules,
wherein the flow distributor and the flow collector are fluidically connected to the circulation pump and the plurality of hollow fibre modules and are arranged substantially centrally on a longitudinal axis, and
wherein the plurality of hollow fibre modules are arranged coaxially to each other about the longitudinal axis.

2. The cross-flow filtration system according to claim 1, wherein the flow distributor includes a body of rotation having a point and a peripheral lateral surface, arranged in such manner that the flow distributor distributes the suspension substantially evenly to the plurality of hollow fibre modules when the circulation pump directs the flow at the point.

3. The cross-flow filtration system according to claim 2, wherein the lateral surface is concave.

4. The cross-flow filtration system according to claim 2, wherein the body of rotation has a conical shape.

5. The cross-flow filtration system according to claim 3, wherein the body of rotation has a plurality of recesses arranged evenly about the point in the lateral surface to guide the suspension along the first lateral surface.

6. The cross-flow filtration system according to claim 1, wherein the flow collector includes a body of rotation having a point and a peripheral lateral surface, arranged in such manner that the flow collector guides the suspension to the circulation pump when the plurality of hollow fibre modules direct the flow at the lateral surface.

7. The cross-flow filtration system according to claim 6, wherein the lateral surface is concave.

8. The cross-flow filtration system according to claim 6, wherein the body of rotation has at least one of a conical shape and a right circular cone shape.

9. The cross-flow filtration system according to claim 7, wherein the body of rotation has a plurality of recesses arranged evenly about the point in the lateral surface to guide the suspension along the lateral surface.

10. The cross-flow filtration system according to claim 1, further comprising a vent fluidically connected to the plurality of hollow fibre modules and the circulation pump.

11. The cross-flow filtration system according to claim 1, further comprising at least one rack connected mechanically to the plurality of hollow fibre modules and the circulation pump to stabilise the plurality of hollow fibre modules.

12. The cross-flow filtration system according to claim 11, further comprising a plurality of racks, wherein each one of the plurality of racks is associated with at least one of the plurality of hollow fibre modules.

13. The cross-flow filtration system according to claim 1, wherein the plurality of fibre modules are arranged equidistantly with respect to each other from the longitudinal axis.

14. The cross-flow filtration system according to claim 1, wherein the plurality of hollow fibre modules are arranged in a rotationally symmetrical manner about the longitudinal axis.

15. The cross-flow filtration system according to claim 1, wherein at least one of (i) at least two of the plurality of hollow fibre modules are each fluidically connected to the flow distributor via a connecting section, wherein the connecting sections of the at least two of the plurality of hollow fibre modules are configured as non-variable parts and (ii) at least two of the plurality of fibre modules are each fluidically connected to the flow collector via a connecting section, wherein the connecting sections of the at least two of the plurality of hollow fibre modules are configured as non-variable parts.

16. The cross-flow filtration system according to claim 15, wherein the respective connecting sections are arranged in a rotationally symmetrical manner about the longitudinal axis.

17. The cross-flow filtration system according to claim 1, wherein the plurality of hollow fibre modules are arranged axially parallel along the longitudinal axis.

18. The cross-flow filtration system according to claim 1, wherein the flow distributor includes a first rotating body having a first lateral surface tapering to a first point configured to distribute the suspension uniformly to the plurality of hollow fibre modules when the circulation pump directs the flow towards the first point; and
wherein the flow collector includes a second rotating body having a second lateral surface tapering to a second point configured to guide the suspension to the circulation pump when the plurality of hollow fibre modules direct the flow towards the second lateral surface.

19. The cross-flow filtration system according to claim 2, wherein the body of rotation has a right circular cone shape.

20. A cross-flow filtration system, comprising:
a plurality of hollow fibre modules configured to retain a retentate of a suspension and arranged coaxially to each other about a longitudinal center axis;
a circulation pump fluidically connected to the plurality of hollow fibre modules for facilitating a mechanical flow of the suspension;
a flow distributor configured to distribute the suspension to the plurality of hollow fibre modules;
a flow collector configured to collect the suspension from the plurality of hollow fibre modules;
wherein the flow distributor and the flow collector are fluidically connected to the circulation pump and the plurality of hollow fibre modules, the flow distributor and the flow collector being arranged centrally on the longitudinal axis; and
wherein at least one of:
the flow distributor includes a first rotating body having a first lateral surface tapering to a first point configured to distribute the suspension uniformly to the plurality of hollow fibre modules when the circulation pump directs the flow towards the first point; and
the flow collector includes a second rotating body having a second lateral surface tapering to a second point configured to guide the suspension to the circulation pump when the plurality of hollow fibre modules direct the flow towards the second lateral surface.
